(19) United States
(12) Patent Application Publication
(10) Pub. No.: US 2015/0082176 A1
(43) Pub. Date: Mar. 19, 2015

(54) VISUAL SIMULATOR FOR WIRELESS SYSTEMS

(71) Applicant: Alcatel-Lucent USA Inc., Murray Hill, NJ (US)

(72) Inventors: Mohammad R. Khawer, Lake Hopatcong, NJ (US); Subramanian Vasudevan, Morristown, NJ (US); Rahul N. Pupala, Plano, TX (US)

(73) Assignee: Alcatel-Lucent USA Inc., Murray Hill, NJ (US)

(21) Appl. No.: 14/027,687

(22) Filed: Sep. 16, 2013

(51) Int. Cl. H04L 12/26; G06F 3/0484

(52) U.S. Cl. CPC H04L 43/045; G06F 3/0484
USPC 715/733

(57) ABSTRACT

An illustrative example network simulator device includes a display and a processor that uses information simulating network performance including a plurality of network parameters. The processor selectively controls the display to present a visual representation of a network including a plurality of base stations and a plurality of mobile stations. The display also presents a visual representation of at least some of the generated information including information regarding at least one of the network parameters from a network perspective, a base station perspective, and a mobile station perspective.

### 1. TECHNICAL FIELD

The subject matter of this document pertains to visual simulators. More particularly, and without limitation, the subject matter of this document pertains to a visual simulator for wireless systems that provides information from a variety of perspectives.

### 2. BACKGROUND

Wireless communication systems have been significantly expanding in scope and capability. Network providers are striving to find ways to implement new or additional wireless system infrastructure to accommodate growing subscriber needs and desires. There is a need, for example, to support a much larger number of cells of varied physical dimensions and to support multiple air interfaces and bands of operation with more dynamic interactions between them. Additionally, growing network use and capability introduces additional temporal and spatial changes in the tide of wireless traffic.

While a variety of engineering tools are available to assist in the design or improvement of wireless networks, their limitations do not allow them to adequately address the needs of current network designers. For example, some engineering tools may include a visual representation of the spatial distribution of wireless signals to provide an indication of signal strength or signal-to-interference ratio within a certain geographic area. Such tools may be useful for choosing an appropriate location for a cell site. These tools do not, however, have the ability to incorporate dynamics that are inherent in wireless systems. For example, such tools do not have the capability to address the various aspects of base station operation that are adapted to changing conditions during network operation. Without any information regarding these aspects, an engineer has limited information upon which to base a network design.

Another limitation with known network planning tools is that they typically only provide aggregated metrics of user and network performance. This type of information is not capable of providing the insights needed to understand the intricacies of network operation and typically do not identify where potential improvement or tuning in the network may be useful.

### SUMMARY

An illustrative example network simulator device includes a display and a processor that uses information simulating network performance including a plurality of network parameters. The processor selectively controls the display to present a visual representation of a network including a plurality of base stations and a plurality of mobile stations. The display also presents a visual representation of at least some of the generated information including information regarding at least one of the network parameters from a network perspective, a base station perspective, and a mobile station perspective.

An example network simulator device provides a visual representation that includes respective indicators of the base stations and respective indicators of the mobile stations. The visual representation also includes motion of the respective indicators of the mobile stations corresponding to respective movement of the mobile stations relative to at least one of the base stations.

An illustrative example method of simulating a network on a display includes selectively controlling a display to present a visual representation of a network including a plurality of base stations and a plurality of mobile stations. At least some of the information simulating network performance is included in the visual representation, such as information regarding at least one network parameter from a network perspective, a base station perspective, and a mobile station perspective.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates a network simulator device designed according to an embodiment of this invention.

FIG. 2 schematically illustrates an example visual representation provided by a device such as that shown in FIG. 1.

FIG. 3 schematically illustrates selected features of an example visual representation, such as the one shown in FIG. 2.

FIG. 4 schematically illustrates additional features of an example visual representation designed according to an embodiment of this invention.

FIG. 5 is a flowchart diagram summarizing an example approach to simulating a network on a display.

### DETAILED DESCRIPTION

Disclosed embodiments of a visual simulator provide advanced wireless system modeling and simulation features. With the disclosed embodiments, it is possible to analyze evolving wireless network conditions from at least three perspectives; those of the mobile station (or user equipment), the base station, and the core network. A variety of visual features are included that provide concrete, actionable insights into different facets of system behavior.

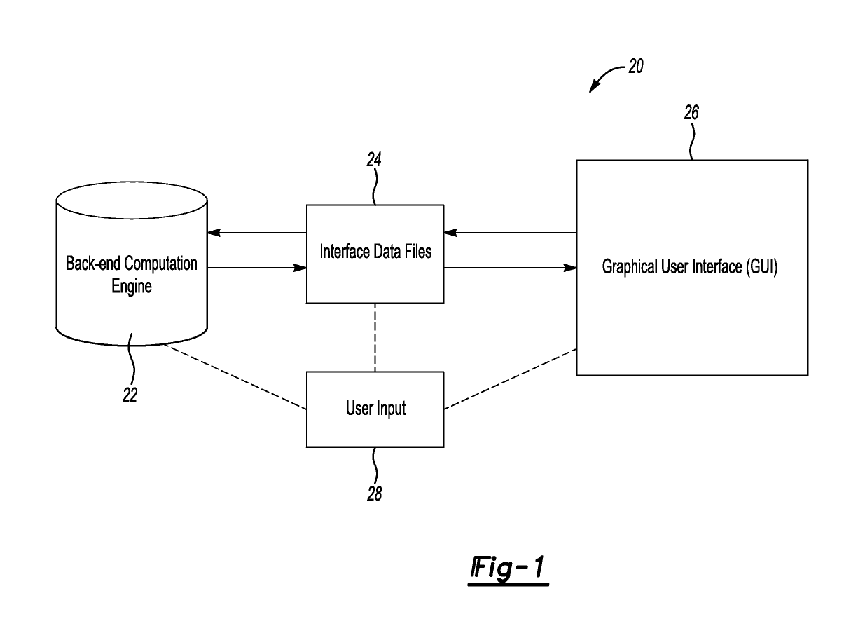

FIG. 1 schematically illustrates an example network simulator device 20. At least one processor 22 includes suitable programming for using information that simulates network performance. The processor 22 in some examples generates information, such as a plurality of network parameters that are associated with network operation during a simulation. In other examples, the network simulation information is generated by another computing device and provided to the processor 22. A plurality of interface data files schematically represented at 24 facilitate information from the processor 22 being provided to a display 26. The processor 22 controls the display 26 to present a visual representation of a network and a variety of features of that network. The example arrangement in FIG. 1 includes a user interface 28 that allows a user to select information to be presented on the display 26. The user interface 28 may include, for example, a keyboard, a pointer, or be embodied in a touch screen of the display 26.

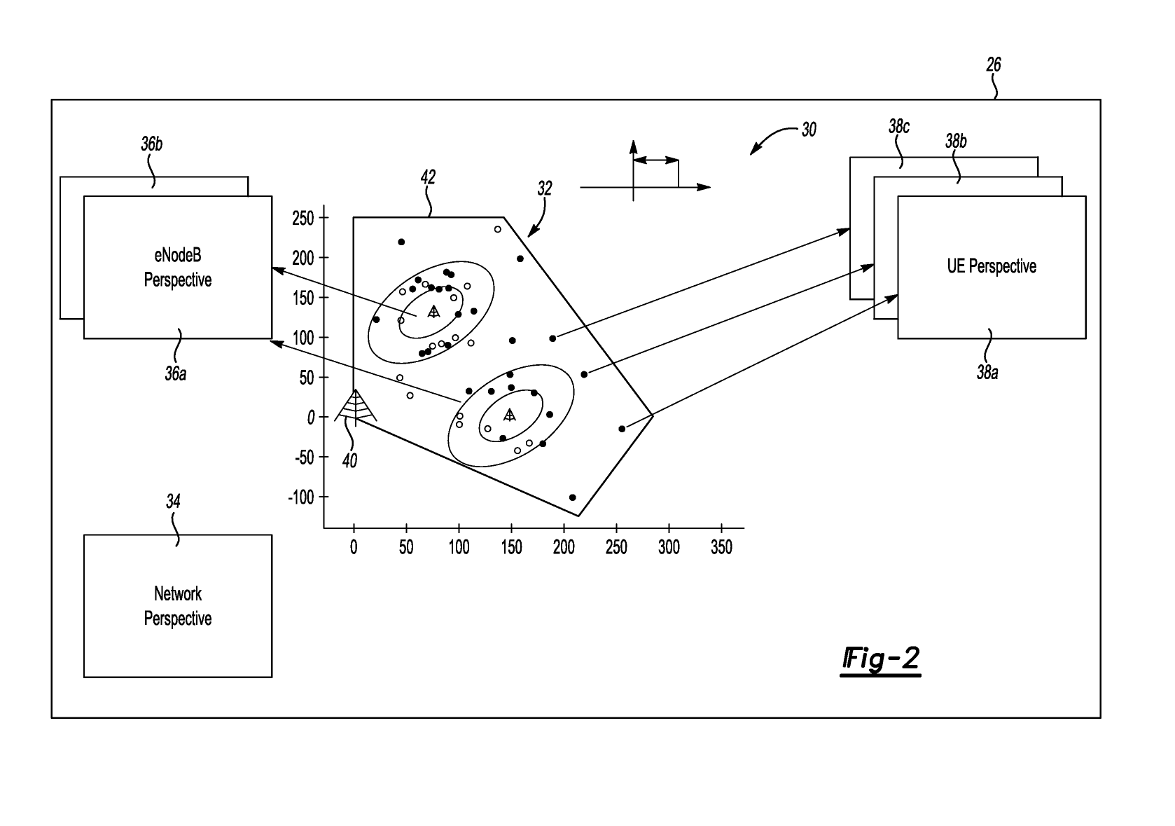

FIG. 2 schematically illustrates an example visual representation 30 on the display 26. The example visual representation 30 includes a representation of a network shown at 32 and a plurality of perspectives regarding at least one network parameter. In this example, there is a network perspective schematically shown at 34, a base station perspective schematically shown at 36 and a mobile station perspective shown at 38. As there is more than one base station in the example network, multiple base station perspectives 36A and 36B are included in the example of FIG. 2. Similarly, there are multiple mobile stations and multiple mobile station perspectives 38A, 38B and 38C may be selectively presented on the display 26. In an example embodiment where there are m base stations, the processor 22 selectively controls the display 26 to provide a visual representation of up to m base station perspectives 36. In examples where there are n mobile stations, the processor 22 controls the display 26 to present up to n mobile station perspectives.

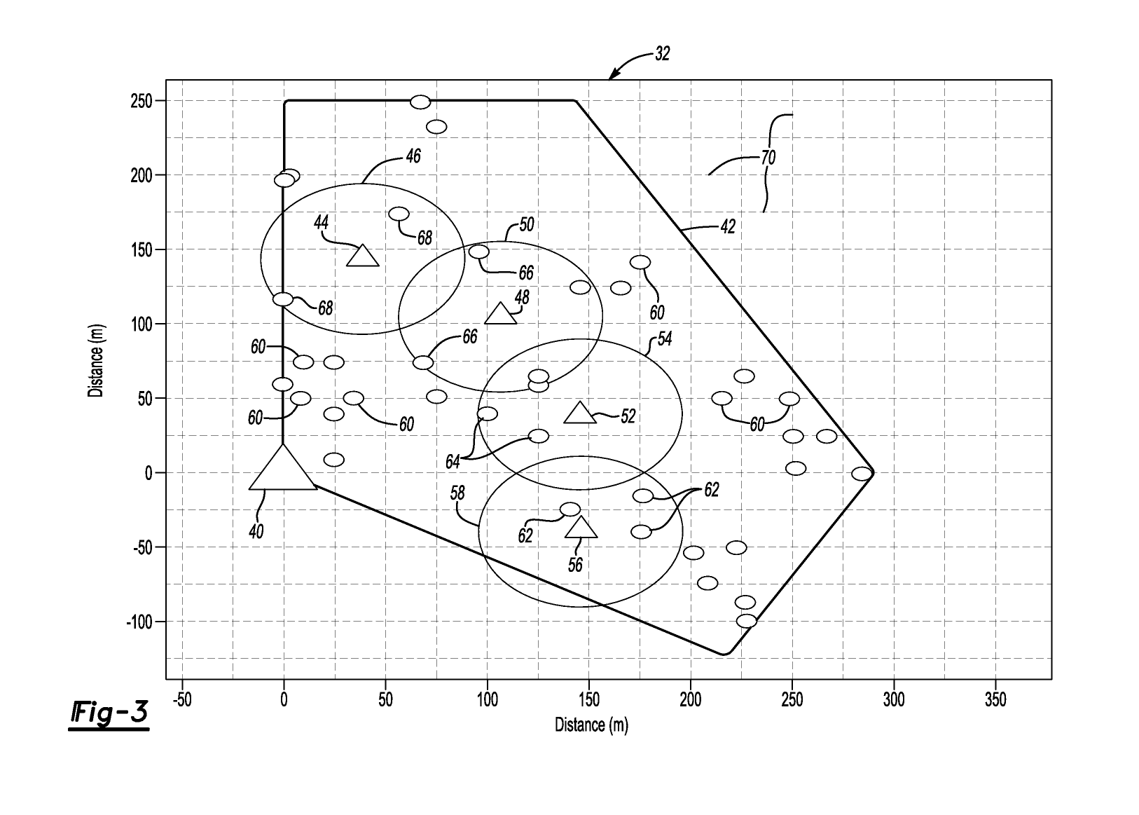

FIG. 3 schematically shows selected details regarding an example visual representation of a network at 32. This example includes a base station 40 that is configured as a macrocell base station serving a cell or sector having a boundary schematically shown at 42. A plurality of outdoor metrocell or indoor picocell (Small Cell) base stations are included within the boundary of the cell or sector 42. One of those base stations is shown at 44 with a coverage area schematically shown at 46. Another of those base stations is shown at 48 with a coverage area schematically shown at 50. A third, small cell base station within the sector 42 is shown at 52 with the coverage area 54 and a fourth base station 56 has an associated coverage area schematically shown at 58. One feature of the illustrated example is that the geographic or spatial relationship among the base stations and their coverage areas can be appreciated from the visual representation.

The visual representation of a network at 32 in FIG. 3 also includes indications of mobile stations. In this example, a plurality of mobile stations 60 are currently being served by the base station 40. Other mobile stations 62 are currently within the coverage area 58 and are being served by the base station 56. Still other mobile stations 64, 66 and 68 are respectively being served by the base stations 52, 48 and 44.

One feature of the illustrated example is that each base station has at least one visual feature that distinguishes it from the other base station. For example, each base station may be represented using a different color. The mobile stations being served by a particular base station may have the same visual feature, such as the same color, as the base station that is currently serving that particular mobile station. This provides a visually recognizable indication of a current feature or status of the network, such as how many mobile stations are being served in each base station coverage area.

Other visual features may be used to distinguish among the base stations, such as a fill pattern within a shape that represents a base station, shading, brightness, blinking or shape.

Utilizing different visual features not only allows for distinguishing one network element from another and to show relationships among network elements, but also allows for providing a visual indication of various network parameters. For example, a base station may have a solid color representation when that base station is relatively heavily loaded but may have a cross hatched color representation when the base station is relatively more lightly loaded. In other words, varying the way in which a base station is presented using visual features allows for providing a visual indication of the status of that base station and the current load it is serving. Similarly, the mobile stations may be presented in different ways to show different mobile station conditions. A mobile station involved in a handoff may blink between colors corresponding to the colors of the base stations involved in the handoff. The intensity or density of a color used for representing a mobile station may vary depending upon the signal strength that mobile station is currently observing from one or more of the base stations. Given this description, those skilled in the art will realize how to customize the use of at least one visual feature associated with the indications in the visual representation 32 for purposes of providing a visual representation of a variety of network operating parameters pertaining to one or more of the network elements that are shown by the indications included in the visual representation of the network.

In the example of FIG. 3, a grid 70 is included along which the mobile stations are permitted to move. In one example, the mobile stations reaching an intersection between lines of the grid 70 use a randomized process for determining whether to continue in the same direction, to turn right, turn left, or reverse direction.

One feature of the illustrated example is that the mobile stations 60-68 are shown moving within the visual representation 32 of the network. Showing the mobile station indicators in motion provides an enhanced ability to visualize that which is occurring within the network during a simulation.

In one example embodiment, the indicators of the base stations and the indicators of the mobile stations are considered smart objects that are plot-able. In the case of the base station indicators, a fixed (e.g., x, y) coordinate set can be mapped to a geographical position corresponding to coordinates on an axis figure. The mobile station indicators are moving objects that have coordinates (e.g., x, y) that vary depending on the particular instant in time of the simulation. The smart objects used in this example embodiment have various features.

One feature of the smart objects is that they are detectable when a user interface is used to select the object on the screen. For example, a pointer device may be utilized to point to a particular object. Alternatively, if the display 26 includes a touch screen, the position of the object on the screen may be selected by touching the corresponding portion of a touch screen.

In an example embodiment, smart object detection capability is implemented by utilizing the known windows button motion detection event hook provided by MATLAB. A custom callback function for smart object detection includes logic to detect three types of smart object (i.e., macro cell, small cells within the macro cell and mobile stations). The current pointer location is determined with respect to the figure object yielding coordinates relative to the display screen. The pointer location is normalized relative to the figure axis to account for geographic zoom-in or zoom-out.

The manner in which the smart objects are established allows for them to be detectable regardless of a zoom level used for a current display mode on the display 26. This feature distinguishes the smart objects of this example embodiment from push-buttons or radio-button objects that may be positioned relative to a figure object on which they are placed, but do not retain geographic or axis coordinate information when the zoom level on a display changes. Maintaining geographic coordinates is accomplished by normalizing the pointer location relative to the figure axis to account for geographic zoom-in or zoom-out. One example embodiment includes obtaining information regarding the axis limit and range in x and y directions. The limit and range of the x axis and the y axis, respectively, provide information to the processor 22 for knowing the zoom level effect on the position of the coordinate system on the screen. With this information, the processor 22 is able to determine the position of the pointer device with respect to the coordinate system of the figure axis. When the pointer is pointing to a smart object, the location of that object in terms of its coordinates is determinable so that the object may be properly identified even though the user may have zoomed in or out when observing the simulation.

The processor 22 has suitable programming to allow it to determine when the pointer is within a fixture axis object and is able to determine if the pointer is over a known smart object, such as a base station indicator or a mobile station indicator. The current pointer location is determined normalized with respect to the axes of the current view.

Determining whether the pointer is over a smart object includes determining whether the location of the pointer is directed at a point within the boundary of a smart object. One example embodiment includes using convex polygon shapes for the smart object indicators. Every point on a straight line segment that joins any two points within a convex polygon is also within the polygon. In other words, a convex polygon includes a plurality of points within the periphery of the shape configured so that any line between any two points within the shape is entirely within the shape, also. Using a convex polygon allows for reliably knowing when a location of a pointer is within the shape corresponding to a smart object indicator.

One feature of using convex polygons is that it can simplify the computations necessary for determining when the pointer is at a location corresponding to a smart object. One example includes using a linear program solution for determining when the location of the pointer is inside a convex polygon.

In one example, once a smart object is detected it may be invoked to perform an appropriate user-defined action, such as launching one of the perspectives described above or to display some statistics about that particular smart object. For example, positioning a pointer over a mobile station indicator will result in a display of at least an identifier of that mobile station even without that mobile station's perspective being opened in a separate window. This feature allows for a user to open a perspective of a particular network element without having to know the identifier of that element because the user can simply point to it on the display 26.

Smart object invocation ability is implemented in one example embodiment by utilizing the known windows button down detection event hook provided by MATLAB. A custom callback uses the value of the global variables that are set by the callback for the motion detector (object recognition) described above. The callback includes logic to determine what type of smart object is being invoked. Once the object type is known, an appropriate user-defined action related to the smart object is invoked and performed by the processor 22.

Another feature of the smart objects in the example embodiment is that their data structures respectively include information that defines and maintains their position relative to other smart objects. Additionally, the smart object data structure includes information about any relationship between the smart object and other smart objects. For example, the information regarding each mobile station smart object includes an indication of the base station currently serving that mobile station. Likewise, each base station smart object data structure includes information regarding each of the mobile stations currently being served by that base station. The processor 22 updates the corresponding data structures when there are changes in such relationships.

Another feature of the smart objects used in this example embodiment is that it is possible to have one smart object within another. This allows for identifying, for example, particular mobile stations that are located within the area on the display 26 corresponding to the coverage area of a base station. With this embodiment it is possible for a coverage area to be configured as a smart object with a base station indicator smart object always within the coverage area smart object and mobile station indicator smart objects to occasionally be within the coverage area smart object. It is also possible in this embodiment to identify multiple base stations within a single sector coverage area as schematically shown in FIG. 3, for example.

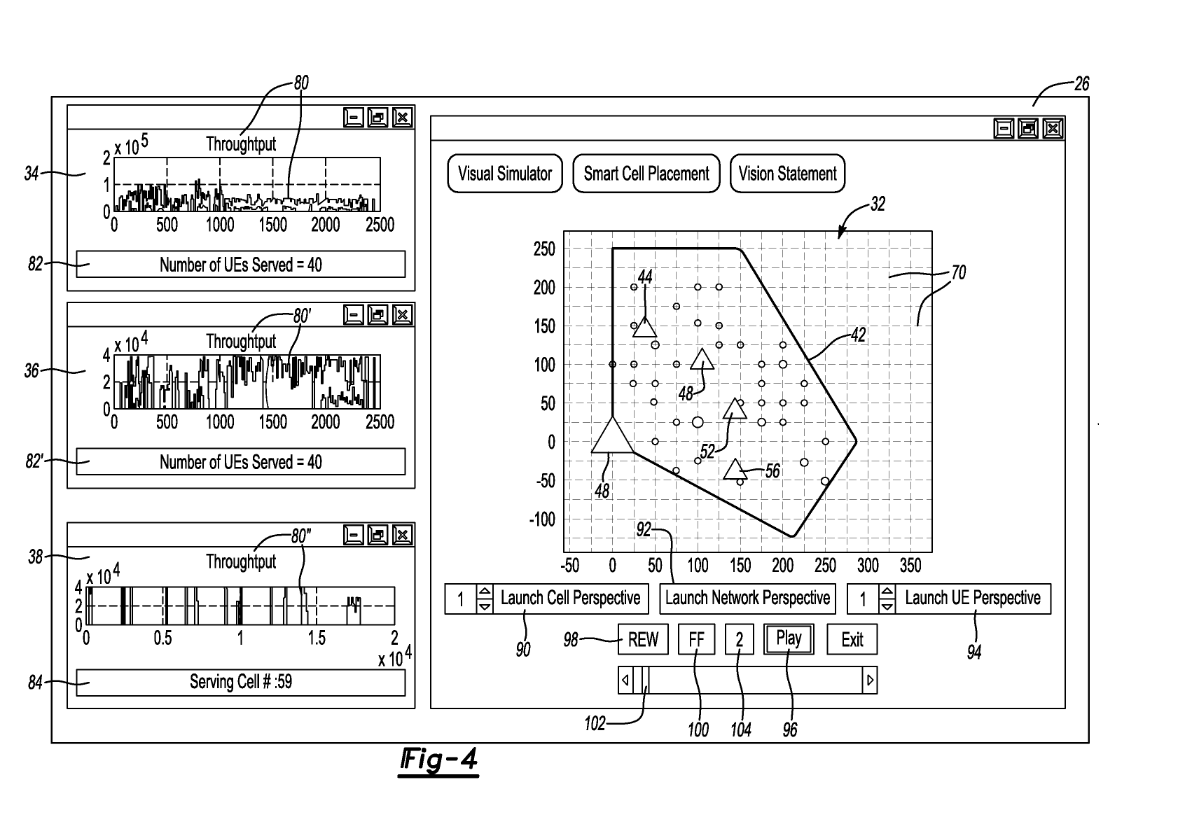

FIG. 4 illustrates an embodiment of a visual representation on the example display 26 that includes the representation of the network at 32. FIG. 4 also illustrates one way in which at least some of the information generated by the processor for simulating network performance is included in the visual representation on the display 26. In this example, information regarding at least one of the network parameters is included in the visual representation from a network perspective at 34, a base station perspective at 36 and a mobile station perspective at 38. In this example, the network parameter throughput is included in the network perspective 34 as shown at 80. The throughput from the base station perspective is shown at 80′. The throughput shown from the mobile station perspective is shown at 80″. FIG. 4 illustrates how the three different perspectives regarding network performance associated with the simulation are included in the visual representation on the display 26. This arrangement of information provides more detail and more information compared to a single, aggregated output regarding throughput, for example. Instead, the throughput information is provided from the three different perspectives 34, 36 and 38.

Additionally, the throughput information is presented in a dynamically changing manner that corresponds to changes in the network shown at 32. For example, as the mobile station indicators 60-68 move about the gridlines 70, the throughput in any of the perspectives 34, 36 or 38 may change and any such changes are reflected in the visual representation provided on the display 26. The simultaneous display of multiple perspectives and the visual representation of the network conditions or arrangement allows for appreciating the significance of the positions of the mobile stations, for example, and how that affects throughput. Additionally, information is available regarding which of the mobile stations is being served by which of the base stations using a visual feature, such as color as described above, to provide even more information to an individual analyzing or designing a network.

In FIG. 4, each of the perspectives 34, 36 and 38 includes a second network parameter. In this example, the network perspective 34 includes a number of mobile stations being served as shown at 82. This parameter is provided from the network perspective and, therefore, includes all of the mobile stations in this particular example. The base station perspective 36 includes a visual representation of the number of mobile stations being served by that particular base station as shown at 82′. The number of mobile stations being served at 82′ may be considered to be the same network parameter as shown at 82 because each pertains to a number of mobile stations being served. As the perspective 38 pertains to one of the mobile stations, it is not necessary or useful to provide an indication of a number of mobile stations being served within that perspective. Instead, the perspective 38 includes a visual representation at 84 of the cell currently serving that particular mobile station. A cell identifier is used in this example. The manner in which cells or mobile stations may be identified can be varied to meet the particular needs of a given situation.

The example of FIG. 4 illustrates how a plurality of network parameters may be included in each of the perspective representations. FIG. 4 also illustrates how the network parameters shown in the different perspectives may be the same parameter or may be different parameters for different perspectives.

Although only one network perspective 34, one base station perspective 36 and one mobile station perspective 38 are illustrated in FIG. 4, it is possible to provide up to m base station perspectives 36 as described above and up to n mobile station perspectives 38 if a user desires that much information to be included on the display 26.

In one example, a user is allowed to select which of the perspectives to be presented in one of two ways. The user may choose an option box or a menu item as shown in FIG. 4 at 90, 92 or 94. In this example, when a user selects the menu item 90, that will launch a base station perspective. With multiple base stations in this example, selecting the menu item 90 opens a window or sub-menu that allows the user to then select the base station of interest for which the user desires a perspective to be shown. In the illustrated example, the user is also able to select which of the network parameters to be included in that perspective. If the user selects the menu item shown at 94, this allows the user to choose which of the mobile station perspectives to be shown and which of the network parameters to be included in that perspective. The menu item shown at 92 launches the network perspective and allows the user to select which of the network parameters to be included in that perspective.

It is also possible for the user to launch one of the perspectives 34, 36 or 38 using active object detection by selecting one of the indicators of a base station or a mobile station, for example. The user interface 28 may include a pointer that the user places over an indication on the display 26 corresponding to a network element about which the user desires to observe the corresponding perspective. This feature allows for a user to select one or more perspectives for observation without having to know the identifier of a base station or mobile station and, instead, allows the user to select information based upon observing the visual representation of the network at 32.

The processor 22 is configured to control information shown on the display 26 based upon which perspectives are currently active or open and included in the visual representation on the display 26. The processor 22 determines, for example, whether a perspective is currently open and which network parameters are on display within that perspective. Any changes in the network based upon movement of the mobile stations, for example, are reflected in the corresponding network parameters shown in the currently active or open perspectives. The processor 22 in this example is configured to only provide information for updating the display 26 based upon that which is shown in currently active perspectives. It is not necessary, for example, to attempt to update information if a particular perspective has been closed or has never been opened during a current simulation session. Limiting the amount of information the processor 22 provides for controlling the display 26 in this manner saves computational resources for running the simulation in the event that the simulation is being run in real time.

Another feature of the illustrated example is that the processor 22 is configured to control how many perspectives are launched or opened as part of the visual representation on the display 26. For example, the processor 22 in this example is programmed to use a defensive checking technique to avoid re-launching one of the perspectives that has already been opened. If a user were to select a particular mobile station perspective and subsequently select that same perspective, rather than opening a new perspective, the processor 22 controls the display 26 to move the re-selected perspective toward a front or prominent position on the display in response to the request of the user.

In one example embodiment, the processor 22 utilizes data structures to manage the three types of perspectives. The data structures include information regarding whether a perspective is active or deleted and its location on the display 26. Whenever a perspective is created or deleted, the data structure is updated according to programming code used by the processor 22. A perspective may be created by an appropriate callback function associated with launching the perspective when a user selects to open a perspective as described above.

In an example embodiment, a protective measure is included concerning the perspective deletion processes. Whenever one of the perspectives is deleted, the figure object for that perspective is not deleted, but instead, a custom callback function that is attached to this event is invoked. The custom callback function for the perspective figure deletion indicates within the data structure concerning that perspective that it should be deleted. The perspective window, however, is left up and running because it is still being updated by the main simulation code from another thread. If the window for that particular perspective were immediately deleted, the code updating the information for that perspective could potentially cause a problem within the operation of the software for the simulation. In the main simulation window, a code check is included if the perspective window is marked for a deletion. Once the perspective has been marked for deletion, the perspective will be deleted along with its associated secondary graphical user interface window and the data structure is initialized to reflect this fact.

FIG. 4 includes display control features that allow a user to select information to be presented on the display 26. For example, the user may select an on-screen button 96, 98 or 100 to control whether to play or pause the simulation, to rewind, or to fast forward from a current displayed condition. This example also includes a time scale bar 102 that allows a user to move through various instances of time that are part of the simulation. The example of FIG. 4 includes an indicator at 104 to show a particular time instant that is currently presented on the display 26. Utilizing any of the features 96-102 allows for changing that which is presented on the display 26. Different positions of the mobile station indicators will be presented based upon different instances of time. Active perspectives that are shown on the display 26 include information that is also updated to correspond to the particular instant of time shown in the visual representation of the network at 32. These features allow a user significant flexibility in how to observe the results of the simulation while being provided with a visual representation of the selected network parameters from the different perspectives.

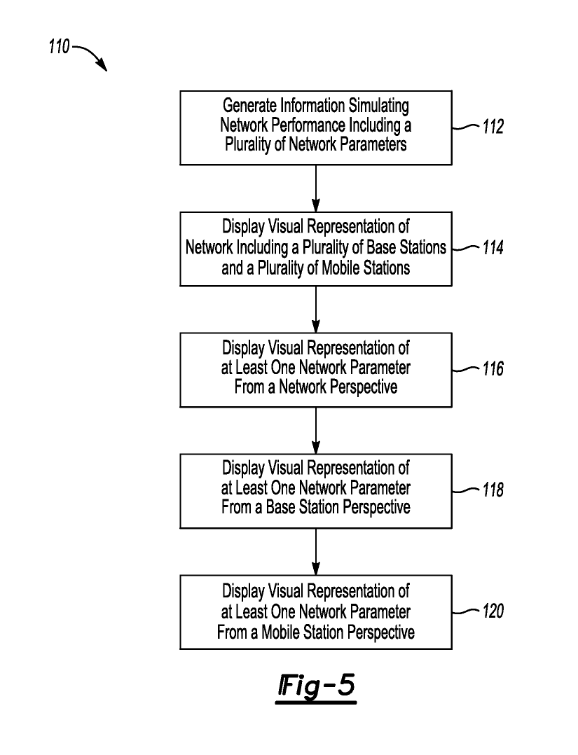

FIG. 5 includes a flowchart diagram 110 summarizing an example approach for providing a simulation of a wireless network. At 112, information is generated simulating network performance including a plurality of network parameters. The manner in which the information is generated and the network performance is simulated can occur using known techniques. The processor 22, for example, may be configured with a known simulation program that allows for determining network parameters such as throughput, signal strength, signal-to-interference ratio, handover status, and number of dropped calls, among others. The processor 22 may run the simulation off line to be observed by a user on the display 26 or the processor 22 may run the simulation in real time.

At 114, a visual representation of the network is displayed including a plurality of base stations and plurality of mobile stations. One example way of accomplishing this is shown at 32 in FIG. 2-4. According to one example embodiment, the main code used for the simulation obtains the x, y location coordinates of all of the objects corresponding to mobile stations at the current simulation time. Based on the location, size and color (e.g., used for depicting cell association), those objects are plotted on an axis object on the display 26. Axis objects are known within Matlab programming environments and can be used in example embodiments of this invention.

Given that the mobile station indicators are shown in motion in the example embodiment, the objects used as mobile station indicators may be plotted using a scatter command. An XOR or EraseMode option may be used to generate a movie effect in embodiments that include Matlab programming. Each simulation time includes a different plot position for the mobile station indicators, the XOR or EraseMode approach effectively erases the previous objects from the display and redraws the mobile station indicators in new positions corresponding to the next simulation instant. The mobility model selected for the simulation controls how the changes in the mobile station indicator positions are accomplished.

As the mobile stations move, there are corresponding changes in the network conditions, such as different signal strengths detected by the mobiles, changes in the serving base station, among others. As the network conditions change, any changes in the network parameters shown in any active perspective representations are updated dynamically so that changes in mobile station positions and the corresponding changes in network conditions are easily visualized simultaneously.

At least one network parameter is included in the visual representation of a network perspective at 116. The processor 22 determines whether the network perspective is active. Assuming that it is, the network perspective is included on the display 26. Whenever the network perspective is active, the processor 22 determines whether it needs to be deleted. If so, the network perspective is deleted and the network perspective data structure is updated accordingly. Assuming there is no need to delete the network perspective, the processor 22 invokes a function for updating any information on the perspective secondary graphical user interface for the current simulation time. There will be times when the network perspective is not active and it need not be displayed. In such instances, the step schematically shown at 116 in FIG. 5 is effectively bypassed.

At least one network parameter is included in the visual representation from a base station perspective at 118. The processor 22 determines whether any of the m possible base station or cell perspectives are active. Whenever one or more of them is active, the processor 22 determines at each simulation instant or time whether any of the base station perspectives should be deleted. If so, the perspective is deleted and the appropriate data structure is updated. When there is no need to delete a base station perspective, the processor 22 invokes a function that updates the information included in that perspective to correspond to the network conditions of the current simulation time. There may be times when no base station perspective is active and the step schematically shown at 118 may essentially be bypassed.

The visual representation includes displaying at least one network parameter from a mobile station perspective at 120. The processor 22 determines whether any of the n possible mobile station perspectives are active. If any are active, the processor 22 determines whether any of them need to be deleted. For any of them that need not be deleted, the processor 22 invokes a function that updates the information included in the perspective shown on the display 26 to correspond to the network conditions for a current simulation time. It is possible for there to be times during an observation of the simulation on the display 26 when none of the mobile station perspectives are active. During such times, the step schematically shown at 120 may be effectively bypassed.

The example device and method allow for obtaining information regarding network parameters included in a simulation with a visual representation of such information from a network perspective, a base station perspective and a mobile station perspective.

While various features and aspects are described above in connection with one or more particular embodiments, those features and aspects are not necessarily exclusive to the corresponding embodiment. The disclosed features and aspects may be combined in other ways than those specifically mentioned above. In other words, any feature of one embodiment may be included with another embodiment or substituted for a feature of another embodiment.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A network simulator device, comprising:
a display; and
a processor that uses information simulating network performance including a plurality of network parameters, the processor selectively controls the display to present
a visual representation of
a network including a plurality of base stations and a plurality of mobile stations; and
at least some information regarding at least one of the network parameters from a network perspective, a base station perspective, and a mobile station perspective.

2. The device of claim 1, wherein
the visual representation includes
respective indicators of the base stations and respective indicators of the mobile stations;
and
motion of the respective indicators of the mobile stations corresponds to respective movement of the mobile stations relative to at least one of the base stations.

3. The device of claim 2, wherein
changes in network conditions are associated with the movement of the mobile stations; and
the processor controls the display to show the motion of the respective mobile station indicators and corresponding changes to the at least one network parameter

4. The device of claim 1, wherein
the visual representation includes
respective indicators of the base stations and respective indicators of the mobile stations;
the indicator of a first one of the base stations has a first visual feature;
the indicator of a second one of the base stations has a second visual feature;
the first visual feature is distinct from the second visual feature; and
the indicators of the mobile stations have the visual feature of the one of the base stations serving the respective mobile stations.

5. The device of claim 4, wherein the visual feature comprises a color.

6. The device of claim 1, wherein the processor selectively controls the display to present the information regarding at least one network parameter from the network perspective, the base station perspective, and the mobile station perspective, simultaneously.

7. The device of claim 1, wherein the at least one network parameter presented from the network perspective is different than the at least one network parameter presented from the base station perspective or the mobile station perspective.

8. The device of claim 1, wherein
there are m base stations;
there are n mobile stations;
the processor selectively controls the display to present up to m base station perspectives; and
the processor selectively controls the display to present up to n mobile station perspectives.

9. The device of claim 1, comprising a user interface configured to allow a user to select information to be presented on the display, the user interface allowing the user to indicate a desire for information to be presented by selecting a displayed item.

10. The device of claim 9, wherein the displayed item comprises at least one of
a displayed object including options to
selectively enable at least one of the perspectives, or
select a change in the visual representation from a currently displayed time to another time;
an indicator of one of the base stations; and
an indicator of one of the mobile stations.

11. The device of claim 10, wherein
the processor responds to a selection of the indicator of the one of the base stations by controlling the display to present at least one of an identifier of the corresponding base station or the base station perspective of the one of the base stations; and
the processor responds to a selection of the indicator of the one of the mobile stations by controlling the display to present at least one of an identifier of the corresponding mobile station or the mobile station perspective of the one of the mobile stations.

12. The device of claim 9, wherein
the displayed item is an indicator of one of a base station or a mobile station; and
the displayed item has a location in terms of coordinates in an axis figure on the display.

13. The device of claim 12, wherein
the processor normalizes boundaries of the axis figure as displayed when the user selects the displayed item such that the location of the item on the display corresponds to the location of the item in the coordinates of the axis figure for a plurality of zoom levels on the display.

14. The device of claim 1, wherein the visual representation of the at least some of the information dynamically changes based on changes in at least one condition or feature of the network.

15. The device of claim 1, wherein
the processor determines a change in a state of the network;
the processor determines whether any of the perspectives are currently displayed as part of the visual representation; and
the processor updates information regarding the at least one of the network parameters corresponding to the determined change in the state of the network only in the currently displayed perspectives.

16. A method of simulating a network on a display, comprising:
selectively controlling the display to present
a visual representation of
a network including a plurality of base stations and a plurality of mobile stations; and
at least some information simulating network performance including information regarding at least one network parameter from a network perspective, a base station perspective, and a mobile station perspective.

17. The method of claim 16, comprising
including respective indicators of the base stations and respective indicators of the mobile stations in the visual representation; and
including motion of the respective indicators of the mobile stations in the visual representation, the motion corresponding to respective movement of the mobile stations relative to at least one of the base stations.

18. The method of claim 16, comprising
including respective indicators of the base stations and respective indicators of the mobile stations in the visual representation; and
displaying the indicator of a first one of the base stations using a first visual feature;
displaying the indicator of a second one of the base stations using a second visual feature, wherein the first visual feature is distinct from the second visual feature; and
displaying the indicators of the mobile stations using the visual feature of the one of the base stations serving the respective mobile stations.

19. The method of claim 16, comprising selectively controlling the display to present the information regarding at least one of the network parameters from the network perspective, the base station perspective, and the mobile station perspective, simultaneously.

20. The method of claim 16, wherein the at least one of the network parameters presented from the network perspective is different than the at least one of the network parameters presented from the base station perspective or the mobile station perspective.

21. The method of claim 16, wherein there are m base stations and n mobile stations and the method comprises
selectively controlling the display to present up to m base station perspectives; and
selectively controlling the display to present up to n mobile station perspectives.

22. The method of claim 16, comprising determining when a user indicate a desire for information to be presented by selecting a displayed indicator of a base station or an indicator of a mobile station from the visual representation;
controlling the display to present at least one of an identifier of the corresponding base station or the base station perspective of the one of the base stations in response to a user selection of the indicator of the one of the base stations; and
controlling the display to present at least one of an identifier of the corresponding mobile station or the mobile station perspective of the one of the mobile stations in response to a user selection of the indicator of the one of the mobile stations.

23. The method of claim 16, comprising dynamically changing the visual representation of the information based on changes in at least one condition or feature of the network.

24. The method of claim 16, comprising
determining a change in a state of the network;
determining whether any of the perspectives are currently displayed as part of the visual representation; and
updating information regarding the at least one of the network parameters corresponding to the determined change in the state of the network only in the currently displayed perspectives.
